(19) United States
(12) Patent Application Publication
(10) Pub. No.: US 2007/0124968 A1
(43) Pub. Date: Jun. 7, 2007

(54) Display with movable components

(76) Inventors: Douglas R. Oudekerk, Saint Paul, MN (US); John K. Lampe, Saint Paul, MN (US)

Correspondence Address: John K. Lampe, 262 Griggs Street South, St. Paul, MN, 55105, US

(21) Appl. No.: 11/633,920

(22) Filed: Dec. 5, 2006

Related U.S. Application Data
(60) Provisional application No. 60/742,283, filed on Dec. 6, 2005.
(60) Provisional application No. 60/802,048, filed on May 22, 2006.

(51) Int. Cl. G09F 7/00

(52) U.S. Cl. 40/488

(57) ABSTRACT

In one embodiment, a display comprising: a sleeve having a first guide; a movable member that moves in relation to the sleeve, the movable member having a second guide; and a slider slidably secured to the first guide and slidably secured to the second guide; whereby movement of the member causes the first guide and the second guide to cooperate in directing movement of the slider. In another embodiment, a display comprising: a sheet having a front side and a back side; a rotatable member positioned on the front side of the sheet; a wheel positioned on the back side of the sheet; a shaft extending through the sheet, the shaft joining the rotatable member to the wheel; and a member slidable in relation to the sheet and to the wheel, the member having a surface for contacting the wheel and causing the wheel and the rotatable member to rotate when the member slides.

This application claims the benefit of U.S. Provisional Application Nos. 60/742,283 filed on Dec. 6, 2005 and 60/802,048 filed on May 22, 2006.

### FIELD OF INVENTION

The present invention generally relates to a display with movable components. Specifically, it can relate to a greeting card with movable components.

### BACKGROUND

Decorative displays such as a greeting cards with movable components are well known in the art. These can include, for example, cards that incorporate “pop-up,” “view changing,” or “pull out” features.

The prior art suffers from certain shortcomings or limitations. The purpose of the present invention is to overcome these and other shortcomings or limitations in the prior art.

### SUMMARY OF THE INVENTION

The present invention generally relates to a decorative display with movable components. In at least one embodiment, the invention can be a greeting card comprising a sleeve having a front wall, a back wall, a closed end, and an open end. A sliding panel can be slid by hand in and at least part-way out of the open end of the sleeve. A distal end of the sliding panel can be oriented toward the closed end of the sleeve. The sliding of the sliding panel can cause a slider to move. The movement of the slider can be controlled by guides. The guides can be a wire guide attached to the sliding panel and a slot in the front wall of the sleeve. As a user pulls the sliding panel out of the sleeve (or pushes the sliding panel back into the sleeve), the guides (the wire rail and the slot) can control the movement of the slider such that the slider and the sliding panel can move in in different directions. The slider can incorporate a decorative item that forms a part of a moving decorative display.

The above summary of the present invention is not intended to describe each illustrated embodiment, object, advantage, or use of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A is a plan view of a greeting card with movable components in a first position according to the first embodiment.

FIG. 1B is a plan view of a greeting card with movable components in a second position according to the first embodiment.

FIG. 1C is a plan view showing the internal workings of a greeting card with movable components in a first position according to the first embodiment.

FIG. 1D is a plan view showing the internal workings of a greeting card with movable components in a second position according to the first embodiment.

FIG. 1E is a perspective view of the sleeve of a greeting card according to the first embodiment.

FIG. 1F is a plan view of the back side of the sliding panel of a greeting card according to the first embodiment.

FIG. 1G is a side, partially cut-away view of the slider, a slot, and the guide of a greeting card according to the first embodiment.

FIG. 1H is a perspective view of the back side of the slider mounted on the guide according to the first embodiment.

FIG. 2A is a plan view of a greeting card with movable components in a first position according to the second embodiment.

FIG. 2B is a plan view of a greeting card with movable components in a second position according to the second embodiment.

FIG. 3A is a plan view of a greeting card with movable components in a first position according to the third embodiment.

FIG. 3B is a plan view of a greeting card with movable components in a second position according to the third embodiment.

FIG. 4A is a plan view of a greeting card with movable components in a first position according to the fourth embodiment.

FIG. 4B is a plan view of a greeting card with movable components in a second position according to the fourth embodiment.

FIG. 5A is a plan view of a greeting card with movable components in a first position according to the fifth embodiment.

FIG. 5B is a plan view of a greeting card with movable components in a first position showing interior details according to the fifth embodiment.

FIG. 5C is a plan view showing interior details of a greeting card with movable components in a first position according to the fifth embodiment.

FIG. 5D is a plan view showing interior details of a greeting card with movable components according to the fifth embodiment.

FIG. 6A is a view of the front side of the greeting card held in the hands of a recipient according to the sixth embodiment.

FIG. 6B is a perspective, exploded view of the greeting card according to the sixth embodiment.

FIG. 6C is a plan view of the front side of the greeting card according to the sixth embodiment.

FIG. 7A is a plan view of the front side of the greeting card with the sliding panel partially pulled out according to the seventh embodiment.

FIG. 8A is a perspective, exploded view of a greeting card according to the eighth embodiment.

FIG. 8B is a perspective view of a-greeting card as assembled according to the eighth embodiment.

### DETAILED DESCRIPTION OF THE INVENTION INCLUDING A BEST MODE

Nomenclature

100 greeting card

101 sleeve

102 front wall

103 back wall

104 closed end

105 open end

106 sliding panel

107 distal end of sliding panel

108 proximate end of sliding panel

109 wire guide

110 back side of sliding panel

111 adhesive tape

112 slider

113 tube

114 slot

115 post

116 face

117 star decoration

118 indentation

119 first direction

120 second direction

121 right triangle

122 Christmas tree

123 Christmas tree lights

124 front side of front panel

125 front side of sliding panel

126 decorative or printed matter on sliding panel

200 greeting card

201 sleeve

206 sliding panel

212 slider with sun decoration

214 slot

230 overlay

231 pocket

232 lower end of slot

233 upper end of slot

300 greeting card

301 sleeve

306 sliding panel

312a slider decorated with airplane

312b slider decorated with automobile

312c slider decorated with ship

314a upper slot

314b middle slot

314c lower slot

319 first direction

400 greeting card

401 sleeve

406 sliding panel

412a slider with top half of heart

412b slider with bottom half of heart

414a upper slot

414b lower slot

419 first direction

420 second direction

440 heart shape

441 third direction

500 greeting card

501 sleeve

506 sliding panel

509 wire guide

512 slider decorated with rocket

514 slot

519 first direction

520 second direction

545 tip of rocket decoration

546 periphery of sleeve

600 greeting card

601 sleeve

602 front wall

603 back wall

604 closed end

605 open end

606 sliding panel

607 distal end of sliding panel

608 proximate end of sliding panel

610 back side of sliding panel

618 indentation

619 first direction

620 second direction

625 front side of sliding panel

650 rotating disk

651 folded portion of sliding panel

652 shaft

653 pulley

655 edge of folded portion

656 groove of pulley

657 right hand

658 left hand

659 hypnosis spiral

660 bushing

661 backing

700 greeting card

701 sleeve

706 sliding panel

719 first direction

750 rotating disk

751 folded portion of sliding panel

753 pulley

755 edge of folded portion

765 rack gearing

800 greeting card

801 sleeve

802 front sheet

803 back sheet

806 movable member

812 slider

814a first slot

814b second slot

815 shaft

819 direction of movement of movable member

870a first part of slider

870b second part of slider

871 flap

As disclosed the invention concerns a greeting card or other decorative display. However, the invention is not limited to such uses. The structure of the greeting card may be useful for other purposes. Other purposes might include, for example, in children's books, brochures, or any other use where such a structure might be usable and beneficial. The invention should be understood to encompass these other uses although such other uses may not be discussed below.

### First Embodiment

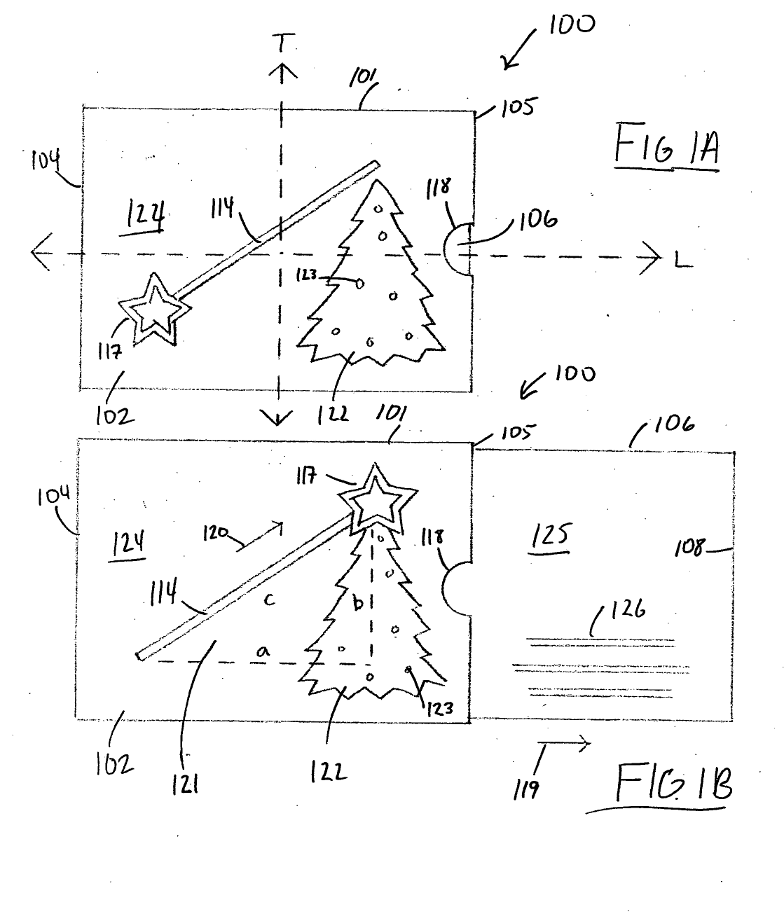

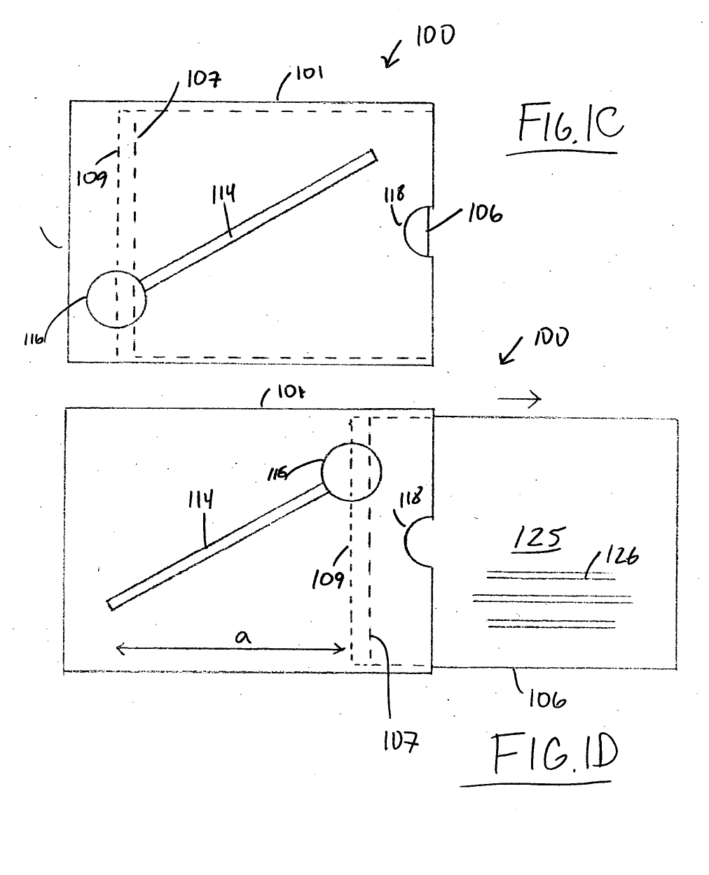

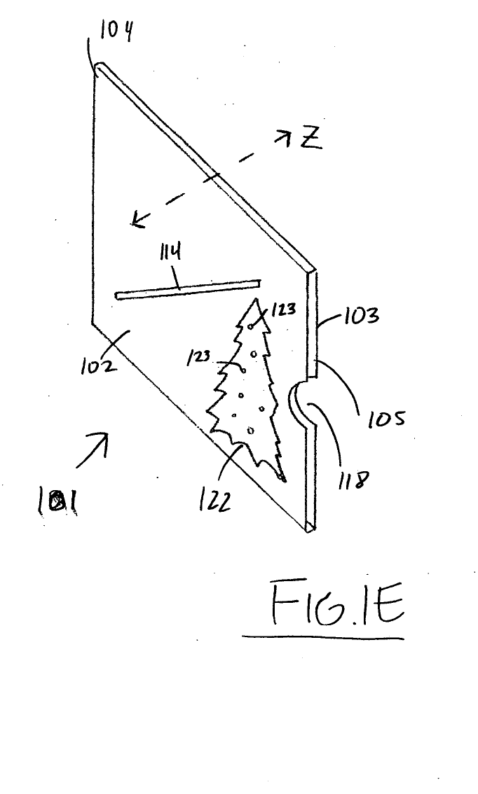

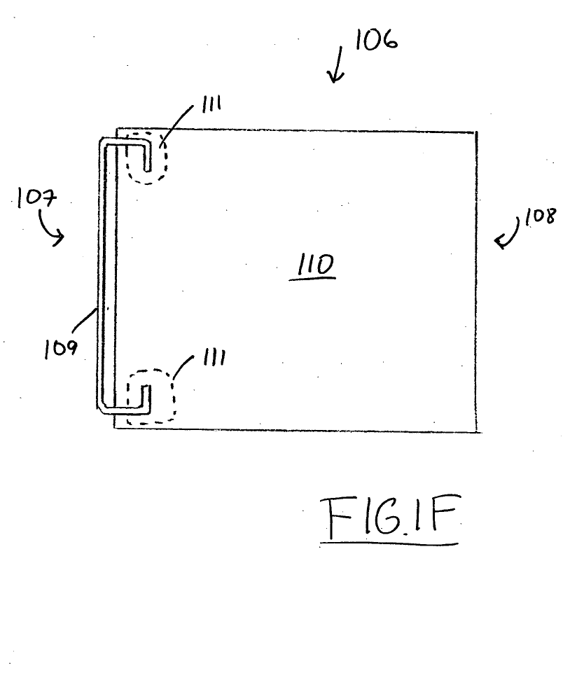

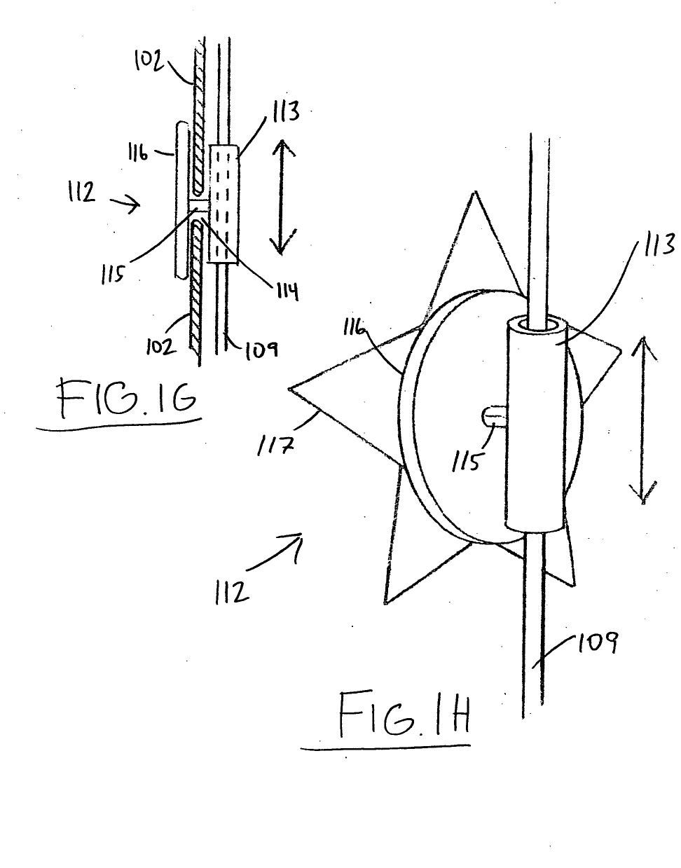

The greeting card 100 shown in FIGS. 1A to 1H can be oriented with a longitudinal centerline L generally bisecting the greeting card 100. The term “longitudinal” refers to a line, axis, or direction in the plane of the greeting card 100 that is aligned with the centerline L. The greeting card shown in FIG. IA can further be oriented with a transverse (or lateral) centerline T that is perpendicular to the longitudinal centerline L. The term “transverse” refers to a line, axis, or direction in the plane of the greeting card 100 that is aligned with the centerline T. The greeting card 100 can further be oriented with a line z as shown in perspective in FIG. 1E, which is perpendicular to the plane formed by centerlines L and T and generally corresponds to the direction associated with the thickness dimension of the greeting card 100.

The length of the greeting card 100 is the maximum dimension measured parallel to the longitudinal centerline L in the longitudinal direction. The width of the greeting card 100 is the maximum dimension measured parallel to the transverse centerline T in the transverse direction. The thickness of the greeting card is the maximum “z” direction dimension measured parallel to the “z” axis.

When a range or interval is disclosed, the disclosure is intended to disclose both the endpoints and the intervals within the range. For example, a range of 0.005 to 0.010 includes 0.005, 0.006 and 0.010 within that range.

The greeting card 100 as shown in FIGS. 1A to 1H can comprise a sleeve 101 having a front wall 102, a back wall 103, a closed end 104, and an open end 105. The front side 124 of the front wall 102 can have decorative or printed matter such as a Christmas tree 122 on it. A sliding panel 106 can slide in and at least part-way out of the open end 105 of the sleeve I0 1 with a distal end 107 of the sliding panel 106 oriented toward the closed end 104 of the sleeve 101. The sliding panel 106 can also have a wire guide 109 affixed to it. The wire guide 109 can be affixed to the back side 110 of the sliding panel 106 with pieces of adhesive tape 111 or other fastening means. In addition, the sliding panel 106 can have decorative or printed matter 126 on its front side 125.

A slider 112 can slide on the wire guide 109. The slider 112 can, for example, have a tube 113 that fits around the wire guide 109. The tube 113 can fit sufficiently loosely on the wire guide 109 to allow the slider 112 to slide freely on the wire guide 109. The slider 112 can also be positioned and slide in a slot 114 in the front wall 102 of the sleeve 101. As shown in FIG. 1G, a post 115 integrated into the slider 112 can fit in the slot 114, and the post 115 can connect the tube 113 to a face 116 as shown in FIGS. 1G and 1H. The face 116 can serve two purposes: first, the face 116 along with the tube 113 can help keep the post 115 positioned in the slot 114. Second, the face 116 can serve as a surface to which items such as a star decoration 117 can be attached as shown in FIGS. 1A, 1B, and 1H.

The greeting card 100 can work as follows. The user can grasp (not shown) the card 100 at the indentation 118 on the sleeve 101. The user can pull the sliding panel 106 in a first direction 119. As the user pulls the sliding panel 106 in a first direction 119 out of the sleeve 101 (or pushes the sliding panel 106 back into the sleeve 101), both the wire guide 109 and the slot 114 can direct the slider 112 in a second direction 120. In this way the slider 112 and the sliding panel 106 can move in different directions 118, 119 but on planes (not indicated) that are generally parallel.

The slider 112 can also prevent the sliding panel 106 from sliding completely out of the sleeve 101 and becoming detached from the sleeve 101. Having the slider 112 slidably connected to both the wire guide 109 and the slot 114 can prevent this detachment under normal use.

The movement of the slider 112 in relation to the sliding panel 106 is also unique. When the user pulls out the sliding panel 106, the slider 112 can move farther than the sliding panel 106 moves. As shown in FIG. 1B, the sliding panel 106 can move a distance d. As shown in FIGS. 1C and 1D, the wire guide 109 moves a distance a. Because the wire guide 109 is rigidly affixed to the sliding panel 106 as shown in FIG. 1F, the wire guide 109 and the sliding panel 106 move approximately the same distance (i.e., a equals d). The distance a can be considered a side of a right triangle 121 along with sides b and c, with side c as the hypotenuse as shown in FIG. 1B. Because the slider 112 moves along c, the hypotenuse of the right triangle 121, and the sliding panel 106 only moves a distance equal to the length of side a of the right triangle 121, the slider 112 moving along c can be moved farther than the sliding panel 106.

The greeting card 100 and its components can be made of many different materials, many of which are well known in the art. For many applications, the sleeve 101 and the sliding panel 106 can be made of cardstock or similar materials. Preferably the material for the sleeve 101 and the sliding panel 106 should have some rigidity. For example, the slot 114 should be capable of guiding the slider 112 in the desired direction. If the material forming the slot 114 is not sufficiently stiff, the slider 112 could distort or even tear the front wall 102. The slot 114 can also be reinforced (not shown).

The kind of material used for the sleeve 101 and the sliding panel 106 will be determined by the application. For example, for some applications in which a more durable greeting is desirable, the sleeve 101 or the sliding panel 106 can be made of a stiffer plastic film. Even materials such as metal, glass, ceramic, wood or other pulp-based products (such as wood veneers) or fabrics (preferably treated to stiffen the fabric) could be suitable for some applications. Still other materials or combinations of materials may also be preferable for certain applications.

The slider 112 can also be made of many different materials, depending on the application. The slider 112 preferably can be made of a plastic of a kind suitable for injection molding. Injection molding or similar processes can allow the slider to be formed into a unitary piece. However, for certain applications other materials may be suitable. Materials such as other kinds of plastics, metals, glass, ceramic, wood or other pulp-based products can be suitable. Still other materials or combinations of materials may also be preferable for certain applications.

As discussed above, the wire guide 109 can be a separate component which is then affixed to the sliding panel 106. For such a configuration, the wire guide 109 can be tubular shaped wire stock or round plastic stock. Still other materials or combinations of materials may also be preferable for certain applications.

The overall size of the greeting card 100 can vary depending on the application. For example, the greeting card 100 can be slightly smaller than 5 inches wide by 7 inches long (allowing the greeting card 100 to fit in a 5 inch wide by 7 inch long envelope (not shown)). Larger or smaller sized greeting cards 100 than those described may be suitable for various other applications.

The shape of the greeting card 100 and its parts can also vary depending on the application. For most applications, the greeting card 100 can preferable have a rectangular shape. However, for other applications other shapes may be preferable.

The greeting card 100 can be assembled in many different ways. For example, the sleeve 101 can be cut from a unitary sheet stock (not shown) and folded to form the sleeve 101 and held in place with adhesives (not indicated). The slider 112 can be inserted onto the wire guide 109 before the wire guide 109 is attached to the sliding panel 106.

The greeting card 100 as disclosed above can have many uses and can offer several advantages. First, as discussed above, the operation of the greeting card 100 can move the slider 112 in a direction 119 different from the direction 120 in which the sliding panel 106 is pulled. This can unexpected movement can draw the attention and arouse the curiosity of the recipient of the card. Second, the slider 112 can move farther than the distance the sliding panel 106 is pulled. This maximizes use of the space on the front wall 102 of the greeting card 100 and adds another unique element to the greeting card 100. Third, the greeting card 100 can be made to operate very smoothly, allowing the recipient to pull-out and push-in the sliding panel 106 easily and repeatedly. Third, the greeting card 100 can be made of materials that make the greeting card 100 very durable. For example, plastic films and injection molded components can extend the life of the greeting card 100. Fourth, the greeting card 100 can be manufactured economically. Unlike many pop-up cards (not shown), for example, the greeting card 100 can be made without a substantial number of cuts, components, or secondary operations.

Other embodiments (not shown) can have different configurations than those described above. For example, sliders (not shown) can be configured differently especially if the guides (e.g., the slot 114 and the wire guide described above) are configured differently. For instance, the guides could be two slots (not shown) instead of the wire guide 109 and the slot 114 described above. Two wire guides (not shown) could be used. For other applications different kinds of guides such as channels, grooves, and the like (not shown) could be used as guides for sliders and be. within the scope of the invention.

Other embodiments (not shown) can have sleeves that can be configured differently. These other configurations can control in a different way the direction or the way in which the sliding panel slides in relation to the sleeve. These other configurations could include sleeves with tracks or guides; sleeves that only partially enclose a sliding panel; sleeves with open backs or fronts or partially open backs or front. Such variations can still be within the scope of the invention.

Other embodiments (not shown) can have sliding panels that can be configured differently. The sliding panel can have tracks or guides; the sliding panel can have openings cut in it; or the sliding panel can have different shapes than a rectangle. The sliding panel can have different structures attached to it such as tabs and so forth. Such variations can still be within the scope of the invention.

The greeting card 100 could also have additional features not shown or described above. For example, a lighting system (not indicated) and a switch (not shown) could be added to the star decoration 117 and the Christmas tree 122 shown in FIGS. 1A and 1B. When the star 117 is moved to the top of the Christmas tree 122, for example, a switch could light the star 117 or Christmas tree lights 123. Sound chips (not shown), vibrating mechanisms (not shown), and so forth could also be added in additional embodiments. Such variations can still be within the scope of the invention.

Still other features not discussed above can include various decorative or printed matter formed in different ways. For example, messages or decorative matter could be created using glitter, additional cardstock, embossing, three-dimensional objects attached with adhesive, and so forth (not shown). Such variations can still be within the scope of the invention.

In addition, as discussed above, the invention is not limited to structures useful for greeting cards. Other embodiments can include applications of the invention for decorative displays such as ones that might be used in children's books, advertising, bulk mail solicitations, and the like.

Many other embodiments can have still other features than those described above. Some of those other features or configurations are discussed below.

### Second Embodiment

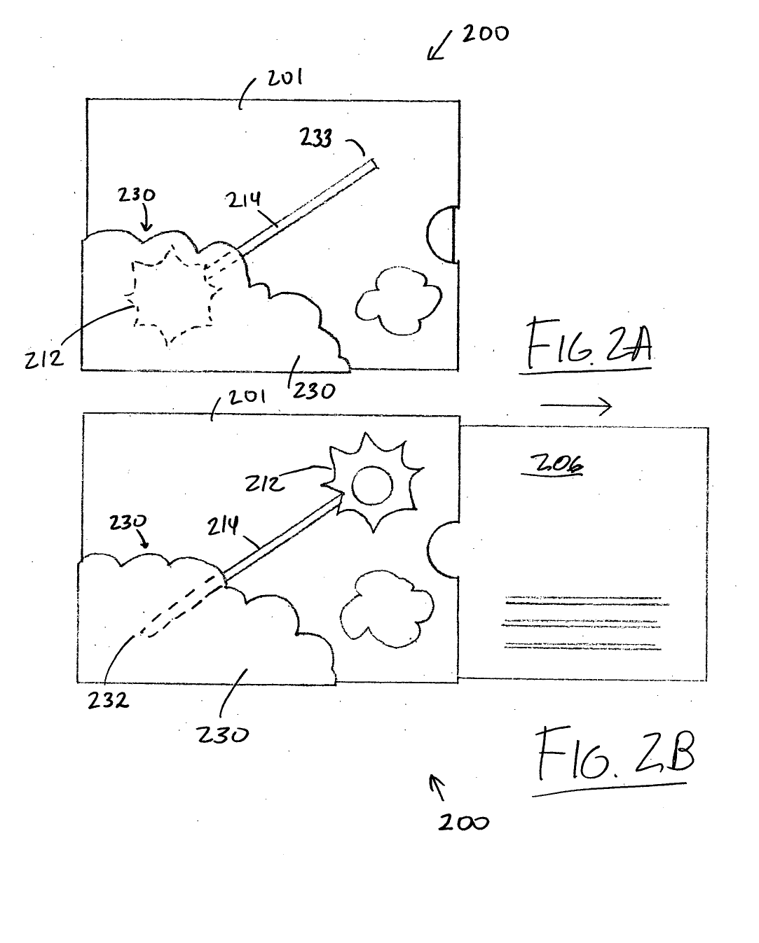

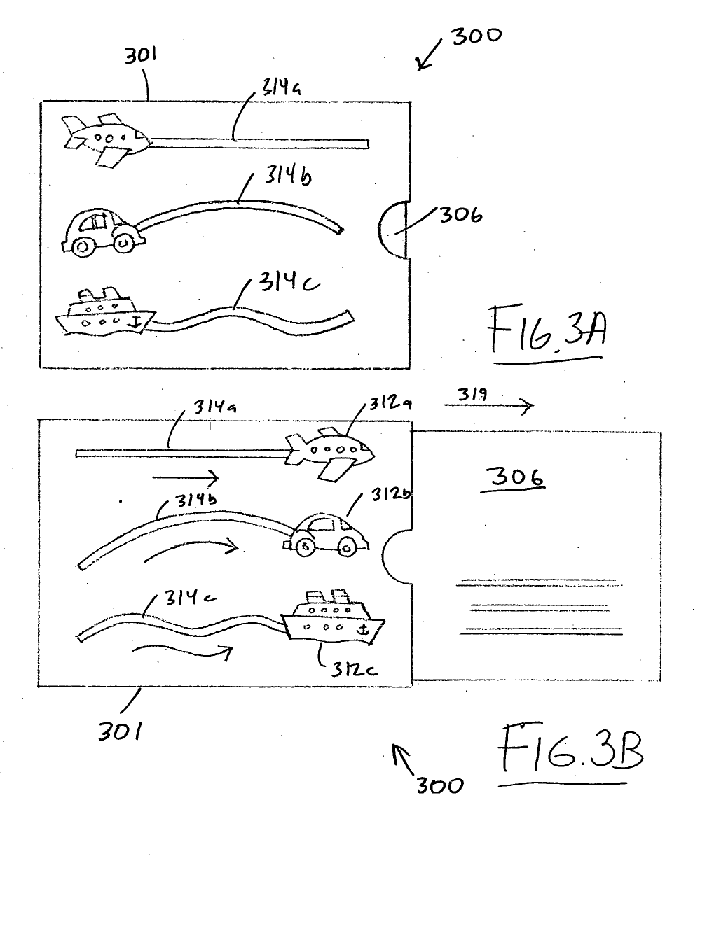

FIGS. 2A and 2B show a greeting card 200 according to a second embodiment. The greeting card 200 can substantially resemble the one shown in relation to FIG. 1A to 1E with at least these differences. The greeting card 200 can have a slider decorated with a sun 212. When the slider 212 is at the lower end 232 of the slot 214, the slider 212 can be obscured by an overlay 230 representing, for example, clouds. (Creating an image of the sun obscured by clouds.) The overlay 230 can be made from a separate piece of material such as cardstock affixed to the sleeve 201. The overlay 230 can form a pocket 231 into which the slider 212 can fit. When the slider 212 is moved toward the upper end 233 of the slot 214, the sun on the slider 212 can be fully visible.

FIGS. 2A and 2B greeting card 200 shows how a slider 212 can be fully obscured (or partially obscured in other embodiments not shown here) and then revealed by a user. Such a greeting card 200 or others resembling it (not shown) can be used with a variety of other decorative or printed matter to convey many different messages with different meanings.

### Third Embodiment

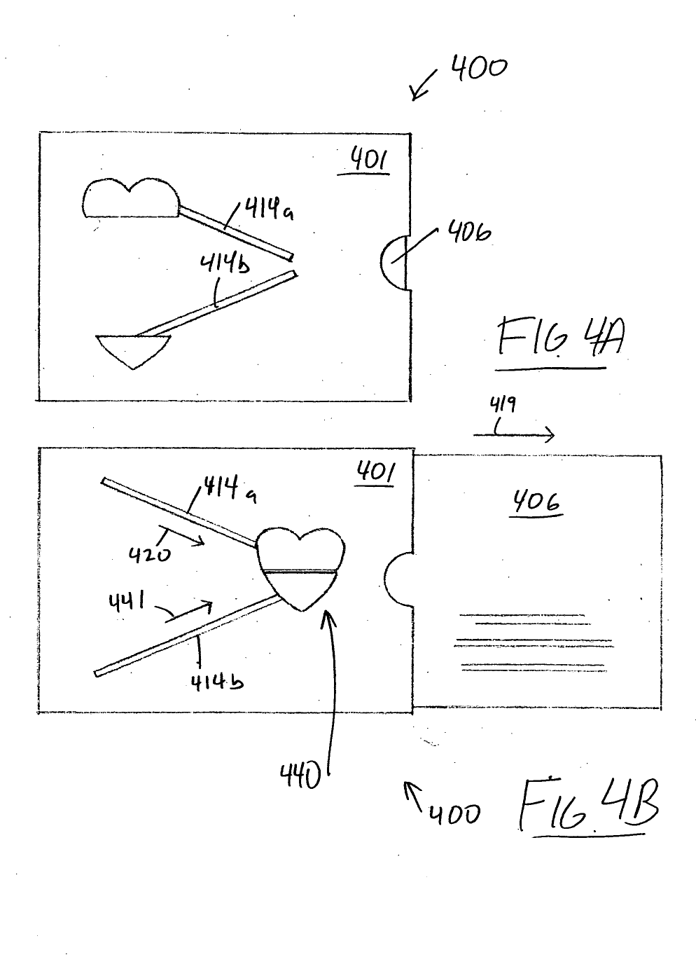

FIGS. 3A and 3B show a greeting card 300 according to a third embodiment. The greeting card 300 can substantially resemble the one shown in relation to FIG. 1A to 1E with at least these differences. The greeting card 300 can have three sliders 312a (decorated with an airplane), 312b (decorated with an automobile), and 312c (decorated with a ship). The sliders 312a to 312c can be slidably connected to a single wire guide (not shown but resembling the wire guide 101 shown in relation to FIGS. 1A to 1H). In addition, the sliders 312a to 312c can be positioned in three slots, 314a, 314b, and 314c. The slots 314a to 314c have different shapes. The lower slot 314c can have a wave shape; the middle slot 314b can have an arc shape; and the upper slot 314a can have a straight shape. By pulling out or pushing in the sliding panel 306 from the sleeve 301, the user can simultaneously cause three uniquely decorated sliders 312a to 312c to move in different ways.

Other embodiment (not shown) could employ still more slot patterns with even more sliders (not shown). The primary limitation on the number of slots and sliders would be the size of the greeting card or other display.

### Fourth Embodiment

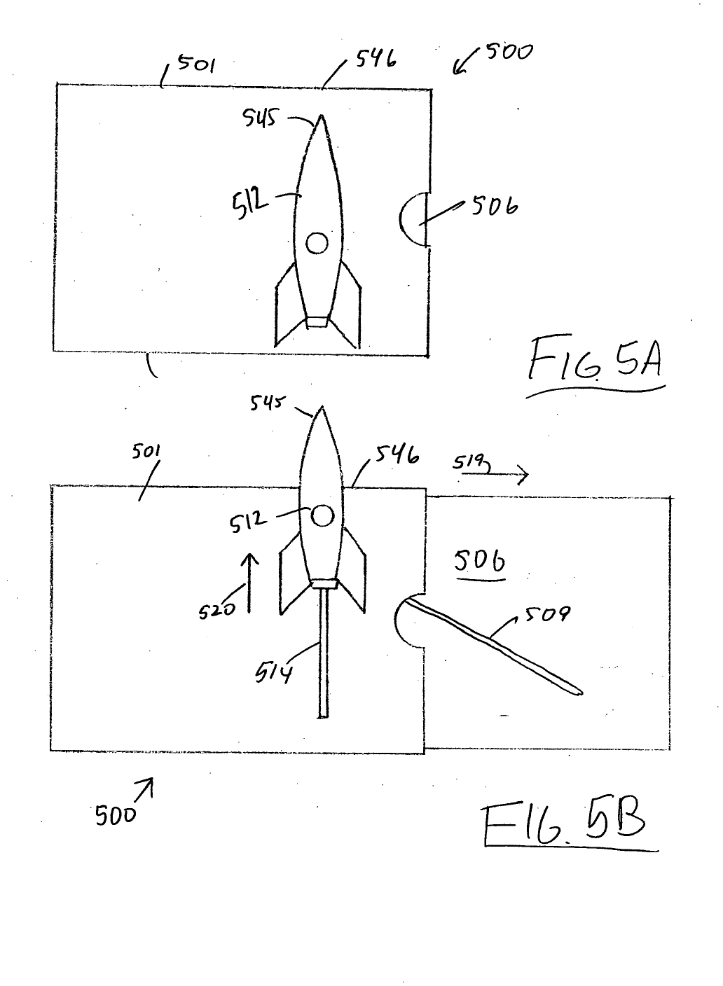

FIGS. 4A and 4B show a greeting card 400 according to a fourth embodiment. The greeting card 400 can substantially resemble the one shown in relation to FIG. 1A to 1E with at least these differences. The greeting card 400 can have two slots 414a and 414b that nearly converge as shown in FIGS. 4A and 4B. The greeting card 400 can have two decorated sliders 412a and 412b, with slider 412a decorated with a top half of a heart and slider 412b decorated with a bottom half of a heart. When the sliding panel 406 is moved in a first direction 419, the sliders 412a and 412b can be caused to converge forming a completed heart image 440.

Other embodiment (not shown) could employ other slot patterns and sliders that use other slot patterns and differently shaped sliders to form other images when a sliding panel is pulled or pushed.

### Fifth Embodiment

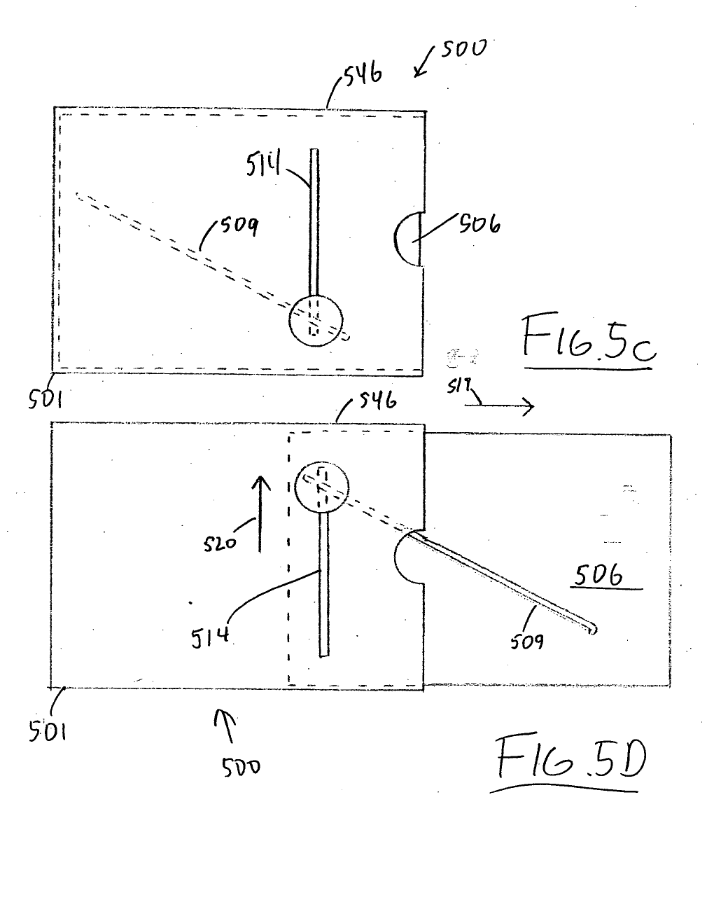

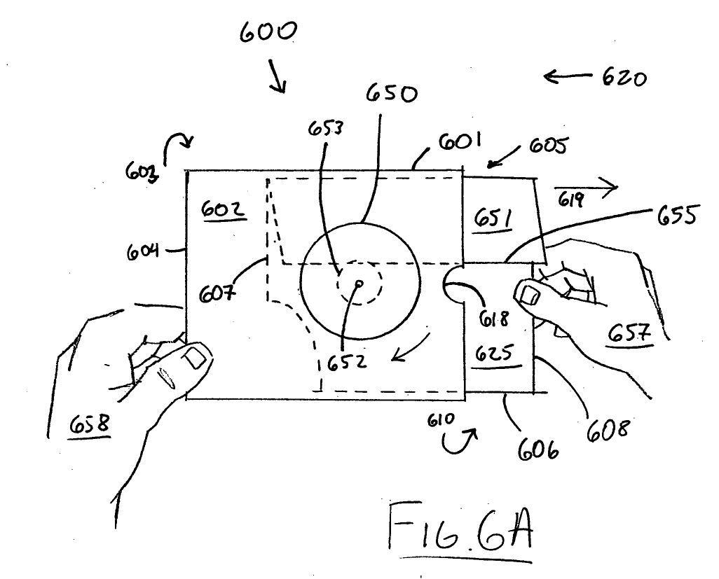

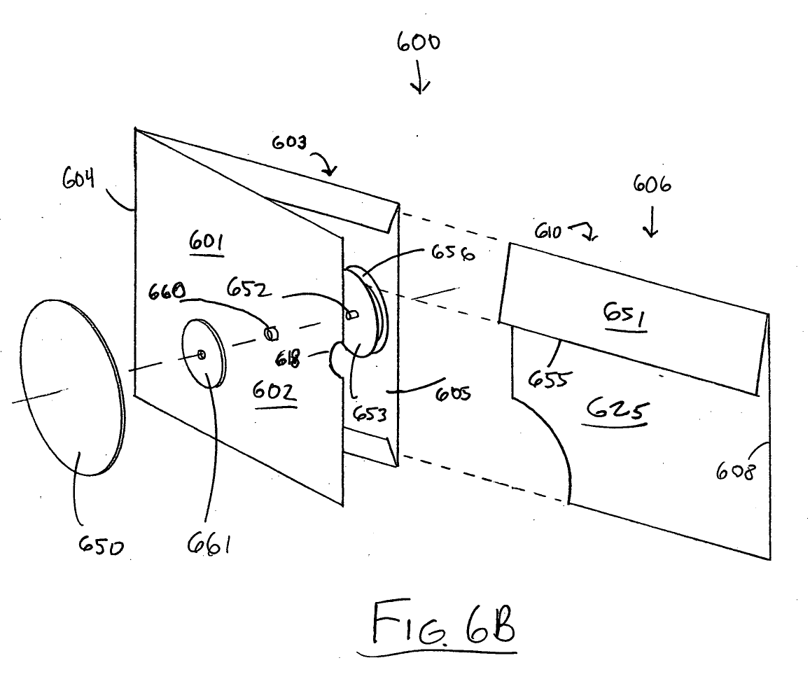

FIGS. 5A to SD show a greeting card 500 according to a fifth embodiment. The greeting card 500 can substantially resemble the one shown in relation to FIG. 1A to 1E with at least these differences. The slot 514 can be positioned transversely to the length of the greeting card 500. The wire guide 509 can run at an angle to length of the card 500. A slider can be decorated with a rocket 512. As the sliding panel 506 is pulled out in a first direction 519, the rocket decoration 517 can move in a second direction 520 in the slot 514, appearing to “blast-off.” The second direction 520 can be substantially perpendicular to the first direction 519. Moreover, the tip 545 of the rocket decoration 517 can move outside the periphery 546 of the sleeve 501 as shown in FIG. 5B.

### Sixth Embodiment

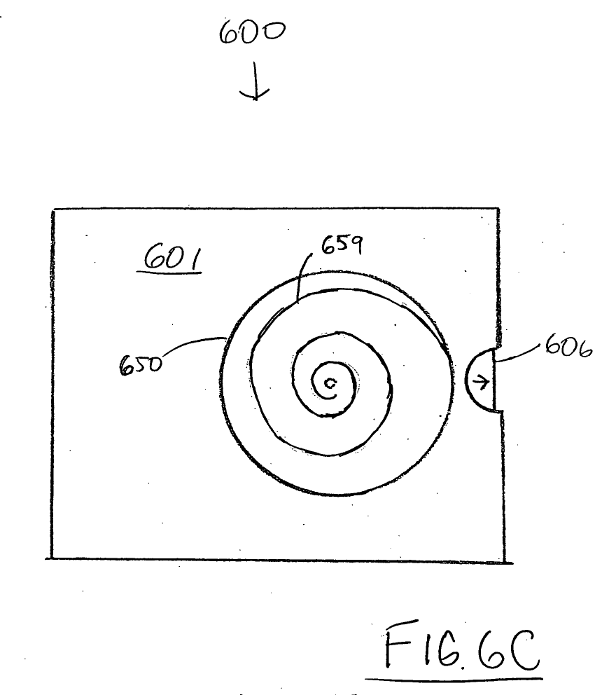

FIGS. 6A to 6C show a greeting card 600 according to a sixth embodiment. The greeting card 600 can substantially resemble the ones shown in relation to FIGS. 1A to 1E, FIGS. 2A and 2B, FIGS. 3A and 3B, FIGS. 4A and 4B, or FIGS. 5A to 5D with at least these differences. The greeting card 600 as shown in FIGS. 6A to 6C can comprise a sleeve 601 having a front wall 602, a back wall 603, a closed end 604, and an open end 605. A sliding panel 606 can slide in and at least part-way out of the open end 605 of the sleeve 601 with a distal end 607 of the sliding panel 606 oriented toward the closed end 604 of the sleeve 601.

A rotating member, in this embodiment, a rotating disk 650, can be positioned on the front side of the greeting card 600. The rotating disk 650 can be attached to attached to a piece of backing 661. The backing can be attached to a shaft 652 that in turn connects to a pulley 653. The pulley 653 can be positioned inside the sleeve 601. The shaft 652 can rotate in a bushing 660.

The sliding panel 606 can have a folded portion 651. An edge 655 of the folding portion 651 can fit within the groove 656 of the pulley 653. The edge 655 can fit snugly in the groove 656.

The greeting card 600 can work as follows. The user can hold the closed end 604 of the sleeve 601 in the left hand 658. The user can grasp the sliding panel 606 in the user's right hand 657 at the indentation 618 on the sleeve 101. The user can pull the sliding panel 606 in a first direction 619. As the user pulls the sliding panel 606 in a first direction 619 out of the sleeve 601 (or pushes the sliding panel 606 back into the sleeve 601), the edge 655 of the folded portion 651 can ride in groove 656 of the pulley 653. This can turn the pulley 653 thereby turning the rotating disk 650. (To improve rotation, gripping material (not shown) such as a gasket or other rubber-like material can fit in or be applied in the groove 656 to improve traction of the edge 655 in the groove 656.)

The rotating disk 650 can have decorative matter printed on it. For example, the rotating disk 650 can have a rotating “hypnosis spiral” 659 printed on it. It also could have many other images printed or otherwise depicted on it too. In addition, the front side 624 of the front wall 602 can have decorative or printed matter (not shown) on it. Finally, the sliding panel 606 can have decorative or printed matter (not shown) on its front side 625.

The greeting card 600 and its components can be made of many different materials, many of which are well known in the art. For many applications, the sleeve 601, the sliding panel 606, and the rotating disk 650 can be made of cardstock or similar materials. Preferably the material for the sleeve 601, the sliding panel 606, and the disk 650 should have some rigidity. For example, the disk 650 should be sturdy enough to survive mailing. In addition, the front wall 602 of the sleeve 601 should be sturdy enough to support the bushing 660.

The kind of material used for the sleeve 601 and the sliding panel 606 will be determined by the application. For example, for some applications in which a more durable greeting is desirable, the sleeve 601 or the sliding panel 606 can be made of a stiffer plastic film. Even materials such as metal, glass, ceramic, wood or other pulp-based products (such as wood veneers) or fabrics (preferably treated to stiffen the fabric) could be suitable for some applications. Still other materials or combinations of materials may also be preferable for certain applications.

The pulley 653, the shaft, 652, the backing 661, and the bushing 660 can also be made of many different materials, depending on the application. These components preferably can be made of a plastic of a kind suitable for injection molding. Injection molding or similar processes can allow the pulley 653 and the shaft 652 to be formed into a unitary piece. However, for certain applications other materials may be suitable. Materials such as other kinds of plastics, metals, glass, ceramic, wood or other pulp-based products can be suitable. Still other materials or combinations of materials may also be preferable for certain applications.

The overall size of the greeting card 600 can vary depending on the application. For example, the greeting card 600 can be slightly smaller than 5 inches wide by 7 inches long (allowing the greeting card 600 to fit in a 5 inch wide by 7 inch long envelope (not shown)). Larger or smaller sized greeting cards 600 than those described may be suitable for various other applications.

The shape of the greeting card 600 and its parts can also vary depending on the application. For most applications, the greeting card 600 can preferable have a rectangular shape. However, for other applications other shapes may be preferable.

The greeting card 600 can be assembled in many different ways. For example, the sleeve 101 and the sliding panel 606 can each be cut from a unitary sheet stock (not shown) and folded respectively to form the sleeve 601 and the sliding panel 606 and held in place with adhesives (not indicated).

The greeting card 600 as disclosed above can have many uses and can offer several advantages. First, the rotating disk 650 can rotate smoothly in the bushing 660. This can be pleasurable for the recipient of the greeting card 600. Second, the sliding panel 606 can be pushed in-and-out repeatedly allowing the recipient or others to enjoy the greeting card 600. Third, the greeting card 600 can be made of materials that make the greeting card 600 very durable. For example, plastic films and injection molded components can extend the life of the greeting card 600. Fourth, the greeting card 600 can be manufactured economically. Unlike many pop-up cards (not shown), for example, the greeting card 600 can be made without a substantial number of cuts, components, or secondary operations.

Other embodiments (not shown) can have different configurations than those described above. For example, a more economical version of the greeting card (not shown) could be manufactured without the bushing 660. The shaft 652 could simply rotate in a hole in the sleeve 601.

Other embodiments could have a rotating member with different decorative matter than shown in FIG. 6C. Still other embodiments could have a rotating member of a shape different than the rotating disk 650 shown in FIGS. 6A to 6C. For example, the rotating member could have many other shapes (not shown) including a rectangular shape, an octagonal shape, an oval shape, a pendulum shape, and so forth.

Other embodiments (not shown) can have a sliding panel that can be configured differently. An alternative sliding panel can have tracks or guides that allow it to slide; the sliding panel can have openings cut in it; or the sliding panel can have different shapes than a rectangle. The sliding panel can have different structures attached to it such as tabs and so forth. Such variations can still be within the scope of the invention.

The greeting card 600 could also have additional features not shown or described above. For example, a lighting system (not indicated) and a switch (not shown) could be integrated into the greeting card 600. When the rotating disk 650 is rotated, a light (not shown) could turn on. Many other devices including sound chips (not shown), vibrating mechanisms (not shown), and so forth could be added in additional embodiments. Such variations can still be within the scope of the invention.

Still other features not discussed above can include various decorative or printed matter formed in different ways. For example, messages or decorative matter could be created using glitter, additional cardstock, embossing, three-dimensional objects attached with adhesive, and so forth (not shown). Such variations can still be within the scope of the invention.

In addition, as discussed above, the invention is not limited to structures useful for greeting cards. Other embodiments can include applications of the invention for decorative displays such as ones that might be used in children's books, advertising, bulk mail solicitations, and the like.

Many other embodiments can have still other features than those described above. Some of those other features or configurations are discussed below.

### Seventh Embodiment

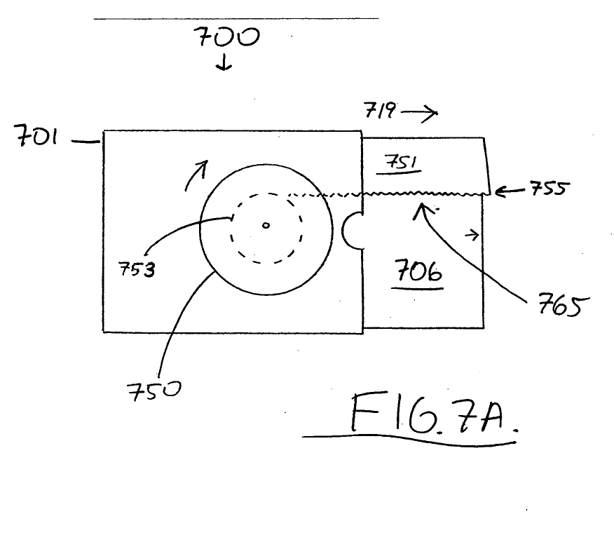

FIG. 7A show a greeting card 700 according to a seventh embodiment. The greeting card 700 can substantially resemble the one shown in relation to FIG. 6A to 6C with at least these differences. The pulley 753 can have pinion gearing (not shown) and the sliding panel 706 can have rack gearing 765. This can allow the pulley 753 and the sliding panel 706 to function with rack-and-pinion gearing.

An advantage can be that production can be simplified. A disadvantage can be a lack of durability because the rack gearing 765 can potentially be damaged.

### Eighth Embodiment

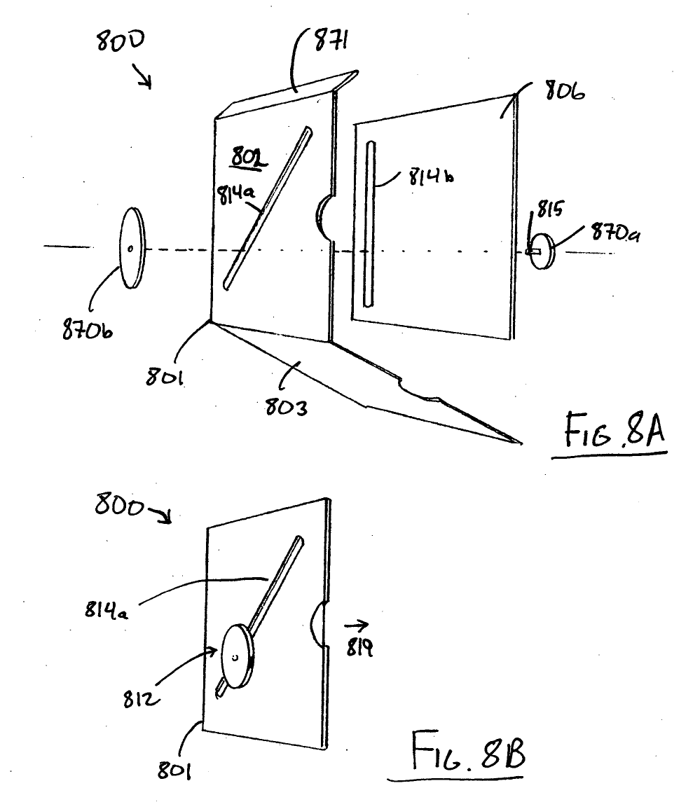

FIGS. 8A and 8B show a greeting card 800 according to an eighth embodiment. The greeting card 800 can substantially resemble, for example: the greeting card 100 shown in FIGS. 1A to 1H according to the first embodiment; the greeting card 400 shown in FIGS. 4A and 4B according to the fourth embodiment; or the greeting card 500 shown in FIGS. 5A to 5D according to the fifth embodiment.

Some of the similarities can be as follows: a display background such as a sleeve 801 comprising for, example, sheets 802, 803 (or walls 102, 103 as described in relation to the first embodiment); guides in the form of slots 814a, 814b (or a wire guide 109 as described in relation to the first embodiment); a movable member 806 (or a sliding panel 106 as described in relation to the first embodiment); or a slider 812. The slider 812 can incorporate a decorative object (not shown) or one can be attached to the slider 812. In addition, when actuated, in this instance by pushing or pulling on the movable member 806 (by hand or in other embodiments (not shown) by, for example, motorized means), the slider 812 can be moved. In addition, although not shown in FIGS. 8A and 8B, the slider 812 can have a decorative object (not shown) attached or incorporated into it.

The greeting card 800 (or, more generally, “display”) can have differences. First, the slider 812 can consist of parts 870a, 870b that the end user can snap together. A first part 870a of the slider 812 can be positioned behind the movable member 806. A second part 870b of the slider 812 can be positioned in front of the front sheet 802. The first and second parts 870a, 870b can be connected by a shaft 815. The first slot 814a can be at an angle to the direction 819 of the movement of the movable member 806. The second slot 814b can be positioned perpendicular to the direction 819 of the movement of the movable member 806. In construction, the first and second parts 870a, 870b of the slider 812 can as shown in FIG. 8A be fastened to each other (with adhesive, with clips, etc. (not shown)) A flap 871 connected to the front sheet 802 can attach to the back sheet 803 of the sleeve 801 with adhesive, etc.

The configuration shown in FIGS. 8A and 8B can have several advantages. One advantage can be that the manner of construction can permit construction by the end user of the greeting card 800. For example, the greeting card 800 can be sold as part of a kit (not shown) requiring some assembly by the end user. The user could construct the greeting card 800 as shown in FIGS. 8A and 8B.

As part of the construction, a decorative object (not shown) could be attached to the second part 870b of the slider 812. (The end user could be presented with a selection of decorative objects in a kit.) For example, the user could attach a sticker (not shown) to the second part 870b. A sticker could be chosen from a selection included with the kit.

Alternatively, in another embodiment (not shown) a slider could be constructed from three or more pieces. A rivet could be used to connect two disks of, for example, card stock. An advantage of this construction method could be savings in manufacturing costs.

Another advantage of greeting card 800 and the embodiments discussed earlier can be the ease of manufacture. Pop-ups typically require a substantial amount of folding to assemble. This can result in a manufacturing process that is time-consuming, difficult to automate, and expensive on a per unit basis. The greeting card 800 and the earlier embodiments discussed above can have the advantage of being much simpler to manufacture and hence less costly.

Modifications

The embodiments or examples discussed above can be combined in various ways without departing from the invention. Moreover, the present invention should not be considered limited to the particular examples described above, but rather should be understood to cover all aspects of the invention as fairly set out in the claims arising from this application. For example, while suitable sizes, materials, packaging and the like have been disclosed in the above discussion, it should be appreciated that these are provided by way of example and not of limitation as a number of other sizes, materials, fasteners, and so forth may be used without departing from the invention. Various modifications as well as numerous structures to which the present invention may be applicable will be readily apparent to those of skill in the art to which the present invention is directed upon review of the present specifications. The claims which arise from this application are intended to cover such modifications and structures.

We claim:

1. A display comprising: a sleeve having a first guide; a movable member that moves in relation to the sleeve, the movable member having a second guide; and a slider slidably secured to the first guide and slidably secured to the second guide; whereby movement of the member causes the first guide and the second guide to cooperate in directing movement of the slider.

2. A display comprising: a sheet having a front side and a back side; a rotatable member positioned on the front side of the sheet; a wheel positioned on the back side of the sheet; a shaft extending through the sheet, the shaft joining the rotatable member to the wheel; and a member slidable in relation to the sheet and to the wheel, the member having a surface for contacting the wheel and causing the wheel and the rotatable member to rotate when the member slides.

3. A display comprising: a sheet having a first guide; a movable member that moves in relation to the sheet, the movable member having a second guide; and a slider slidably secured to the first guide and slidably secured to the second guide; whereby movement of the member causes the first guide and the second guide to cooperate in directing movement of the slider.

4. The display of claim 1, wherein the sleeve comprises a front sheet and a back sheet.

5. The display of claim 4, wherein the guide comprises a first slot in the front sheet.

6. The display of claim 1, wherein the second guide comprises a second slot in the member.

7. The display of claim 1, wherein the second guide comprises a wire attached to the member.

8. The display of claim 1, wherein at least a portion of the slider moves in front of the front sheet.

9. The display of claim 1, wherein the slider comprises decoration.

10. The display of claim 1, wherein the front of the front sheet comprises decoration.

11. The display of claim 1, wherein the front sheet conceals at least a portion of the second guide from view from the front.

12. The display of claim 2, wherein the surface comprises an edge of the member and contact between the edge and a crown of the wheel causes the wheel to rotate when the member is slid.

13. The display of claim 2, wherein the wheel comprises lagging for gripping the surface.

14. The display of claim 2, wherein the surface comprises an edge of the member.

15. The display of claim 14, wherein the edge contacts a crown of the wheel causing the wheel to rotate when the member slides.
